(19) United States
(12) Patent Application Publication
(10) Pub. No.: US 2025/0027791 A1
(43) Pub. Date: Jan. 23, 2025

(54) POSITION SENSING METHOD AND SYSTEM

(71) Applicant: Allegro MicroSystems, LLC, Manchester, NH (US)

(72) Inventors: Solène Bastien, Naves-Parmelan (FR); Alexander Latham, Harvard, MA (US); Emanuele Andrea Casu, Annecy (FR); Rémy Lassalle-Balier, Bures sur Yvette (FR); David Witts, Cambridge (GB); Paul Smith, Cambridge (GB)

(73) Assignee: Allegro MicroSystems, LLC, Manchester, NH (US)

(21) Appl. No.: 18/393,954

(22) Filed: Dec. 22, 2023

Related U.S. Application Data
(63) Continuation-in-part of application No. 18/354,895, filed on Jul. 19, 2023.
(63) Continuation-in-part of application No. 18/475,674, filed on Sep. 27, 2023.

(51) Int. Cl. G01D 5/20; B62D 15/02

(52) U.S. Cl. CPC G01D 5/2053; B62D 15/0215

(57) ABSTRACT

A system, comprising: a processing circuitry that is configured to: receive a signal S1 and a signal S2, the signal S1 being generated by a first receiving coil in response to a first magnetic field, the signal S2 being generated by a second receiving coil in response to the first magnetic field, receive a signal S3 and a signal S4, the signal S3 being generated by a third receiving coil in response to a second magnetic field, the signal S4 being generated by a fourth receiving coil in response to the second magnetic field; calculate a first electrical angle based on signals S1 and S2; calculate a second electrical angle based on signals S3 and S4; and generate an output signal based on the first and second electrical angles.

### CLAIM OF PRIORITY

The present application is filed as a Continuation-in-Part application of U.S. application Ser. No. 18/354,895 (Atty Docket No. ALLEG-A040PUS), filed on Jul. 19, 2023, and entitled: POSITION SENSING METHOD AND SYSTEM, which is herein incorporated by reference in its entirety. The present application is also filed as a Continuation-in-Part application of U.S. application Ser. No. 18/475,674 (Atty Docket No. ALLEG-A160PUS), filed on Sep. 27, 2023, and entitled: INDUCTIVE 360-DEGREE ANGLE SENSOR USING RADIALLY-SEPARATED DUAL TARGET, which is herein incorporated by reference in its entirety.

### BACKGROUND

As is known, sensors are used to perform various functions in a variety of applications. Some sensors include one or more electromagnetic flux sensing elements, such as a Hall effect element, a magnetoresistive element, and a receiving coil to sense an electromagnetic flux associated with proximity or motion of a target object. Sensor integrated circuits are widely used in automobile control systems and other safety-critical applications. There are a variety of specifications that set forth requirements related to permissible sensor quality levels, failure rates, and overall functional safety.

### SUMMARY

According to aspects of the disclosure, a system is provided, comprising: a processing circuitry that is configured to: receive a signal S1 and a signal S2, the signal S1 being generated by a first receiving coil in response to a first magnetic field, the signal S2 being generated by a second receiving coil in response to the first magnetic field, the signal S2 being approximately 90-degrees off-phase from the signal S1; receive a signal S3 and a signal S4, the signal S3 being generated by a third receiving coil in response to a second magnetic field, the signal S4 being generated by a fourth receiving coil in response to the second magnetic field, the signal S4 being approximately 90-degrees off-phase from the signal S3; calculate a first electrical angle based on signals S1 and S2; calculate a second electrical angle based on signals S3 and S4; calculate a difference between the first electrical angle and the second electrical angle; subtract a zero-error coefficient from the difference between the first angle and the second angle to produce a corrected difference; and output an output signal that is generated at least in part based on the corrected difference.

According to aspects of the disclosure, a system is provided, comprising: a processing circuitry that is configured to: receive a signal S1 and a signal S2, the signal S1 being generated by a first receiving coil in response to a first magnetic field that is generated by a first set of conductive features in a target, the signal S2 being generated by a second receiving coil in response to the first magnetic field, the signal S2 being approximately 90-degrees off-phase from the signal S1; receive a signal S3 and a signal S4, the signal S3 being generated by a third receiving coil in response to a second magnetic field that is generated by a second set of conductive features in the target, the signal S4 being generated by a fourth receiving coil in response to the second magnetic field, the signal S4 being approximately 90-degrees off-phase from the signal S3; calculate a first electrical angle based on signals S1 and S2; calculate a second electrical angle based on signals S3 and S4; calculate an angular position of the target based on a difference between the first electrical angle and the second electrical angle and an adjustment coefficient, the adjustment coefficient being based on a count of conductive features in the first set and a count of conductive features in the second set; and output an output signal that is at least in part generated based on the angular position of the target.

According to aspects of the disclosure, a system is provided, comprising: a memory; and a processing circuitry that is configured to: receive a signal S1 and a signal S2, the signal S1 being generated by a first receiving coil in response to a first magnetic field, the first magnetic field being generated by a first set of conductive features, the signal S2 being generated by a second receiving coil in response to the first magnetic field, the signal S2 being approximately 90-degrees off-phase from the signal S1; receive a signal S3 and a signal S4, the signal S3 being generated by a third receiving coil in response to a second magnetic field, the second magnetic field being generated by a second set of conductive features, the signal S4 being generated by a fourth receiving coil in response to the second magnetic field, the signal S4 being approximately 90-degrees off-phase from the signal S3; calculate a first electrical angle based on signals S1 and S2; calculate a second electrical angle based on signals S3 and S4; retrieve a configuration setting from a memory; when the configuration setting has a first value, execute a first process for calculating relative displacement between two different targets that are associated with the first set of conductive features and the second set of conductive features, respectively; and when the configuration setting has a second value, execute a second process for calculating an angular position of a target associated with both the first set of conductive features and the second set conductive features.

According to aspects of the disclosure, a method is provided, comprising: receiving a signal S1 and a signal S2, the signal S1 being generated by a first receiving coil in response to a first magnetic field, the signal S2 being generated by a second receiving coil in response to the first magnetic field, the signal S2 being approximately 90-degrees off-phase from the signal S1; receiving a signal S3 and a signal S4, the signal S3 being generated by a third receiving coil in response to a second magnetic field, the signal S4 being generated by a fourth receiving coil in response to the second magnetic field, the signal S4 being approximately 90-degrees off-phase from the signal S3; calculating a first electrical angle based on signals S1 and S2; calculating a second electrical angle based on signals S3 and S4; calculating a difference between the first electrical angle and the second electrical angle; subtracting a zero-error coefficient from the difference between the first angle and the second angle to produce a corrected difference; and outputting an output signal that is generated at least in part based on the corrected difference.

According to aspects of the disclosure, a method is provided, comprising: receiving a signal S1 and a signal S2, the signal S1 being generated by a first receiving coil in response to a first magnetic field that is generated by a first set of conductive features in a target, the signal S2 being generated by a second receiving coil in response to the first magnetic field, the signal S2 being approximately 90-degrees off-phase from the signal S1; receiving a signal S3 and a signal S4, the signal S3 being generated by a third receiving coil in response to a second magnetic field that is generated by a second set of conductive features in the target, the signal S4 being generated by a fourth receiving coil in response to the second magnetic field, the signal S4 being approximately 90-degrees off-phase from the signal S3; calculating a first electrical angle based on signals S1 and S2; calculating a second electrical angle based on signals S3 and S4; calculating an angular position of the target based on a difference between the first electrical angle and the second electrical angle and an adjustment coefficient, the adjustment coefficient being based on a count of conductive features in the first set and a count of conductive features in the second set; and outputting an output signal that is at least in part generated based on the angular position of the target.

### BRIEF DESCRIPTION OF THE DRAWINGS

FIG. 1 is a diagram of an example of a system, according to aspects of the disclosure;

FIG. 2A is a diagram of an example of a system, according to aspects of the disclosure;

FIG. 2B is a flowchart of an example of a process, according to aspects of the disclosure;

FIG. 2C is a flowchart of an example of a process, according to aspects of the disclosure;

FIG. 2D is a flowchart of an example of a process, according to aspects of the disclosure;

FIG. 2E is a flowchart of an example of a process, according to aspects of the disclosure;

FIG. 3A is a diagram of an example of a target set, according to aspects of the disclosure;

FIG. 3B is a cross-sectional side view of an assembly including the target set of FIG. 3A, according to aspects of the disclosure;

FIG. 4A is a diagram of an example of a target set, according to aspects of the disclosure;

FIG. 4B is a side view of an assembly including the target set of FIG. 5A, according to aspects of the disclosure;

FIG. 5A is a diagram of an example of a target set, according to aspects of the disclosure;

FIG. 5B is a cross-sectional side view of an assembly including the target set of FIG. 5A, according to aspects of the disclosure;

FIG. 5C is a cross-sectional side view of a transmitting coil, according to aspects of the disclosure; and

FIG. 5D is a cross-sectional side view of a transmitting coil, according to aspects of the disclosure.

### DETAILED DESCRIPTION

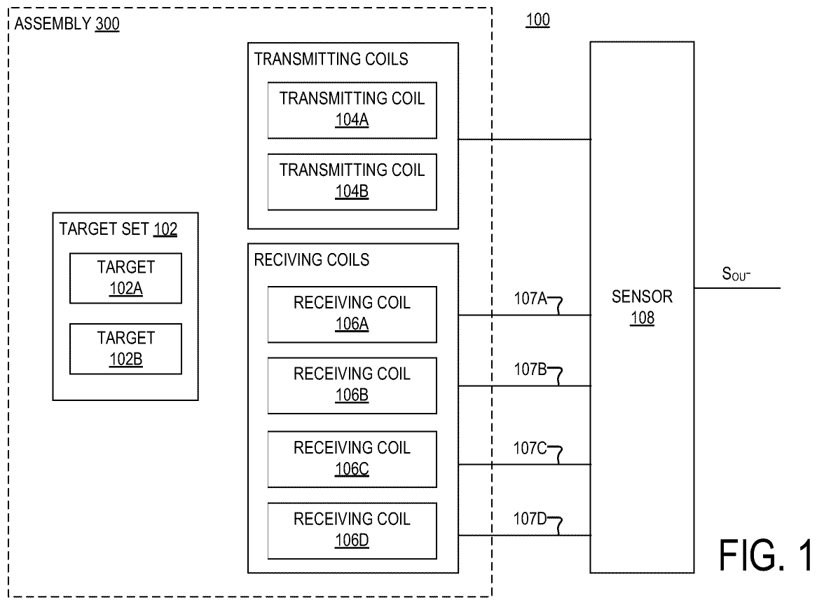

FIG. 1 is a diagram of an example of a system 100, according to aspects of the disclosure. The system 100 may include a target set 102, an assembly 300, and a sensor 108. Assembly 300 may include transmitting coils 104A and 104B and receiving coils 106A, 106B, 106C, and 106D.

Transmitting coil 104A may include a wire (or conductive trace) loop including one or more windings. Transmitting coil 104B may include a wire (or conductive trace) loop including one or more windings. Receiving coil 106A may have a sinusoidal shape, receiving coil 106B may have a co-sinusoidal shape, receiving coil 106C may have a sinusoidal shape, and receiving coil 106D may have a co-sinusoidal shape. In some implementations, the term “sinusoidal shape” may refer to the shape that is defined by bending a wire in the same shape as a sinusoidal waveform, and then further bending the wire into a loop so that the ends come just short of touching each other. In some implementations, the term “co-sinusoidal shape” may refer to the shape that is defined by bending a wire in the same shape as a co-sinusoidal waveform, and then further bending the wire into a loop so that the ends come just short of touching each other. In general, receiving coils 106A-B may generate signals that are 90 degrees off-phase (or approximately 90 degrees off-phase) from each other, and receiving coils 106C-D may generate signals that are 90 degrees off-phase (or approximately 90 degrees off-phase) from each other.

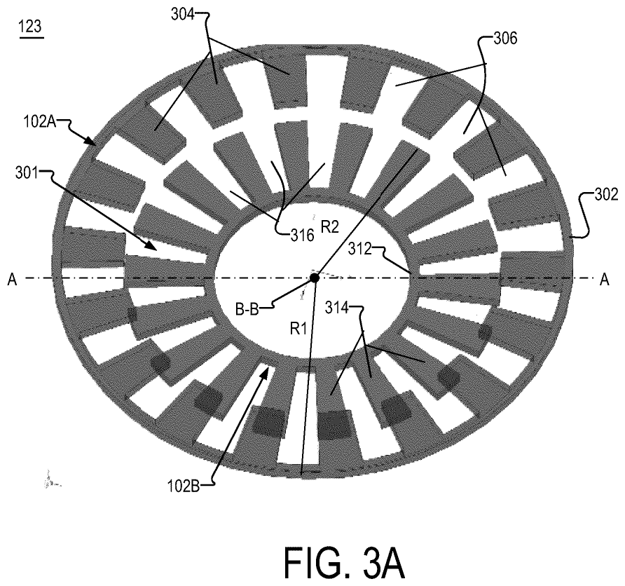

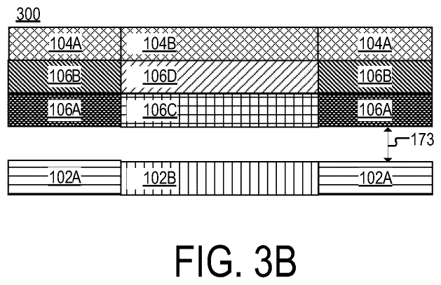

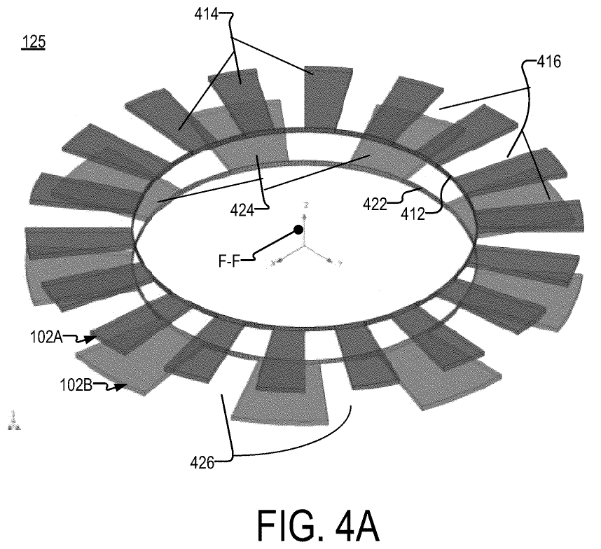

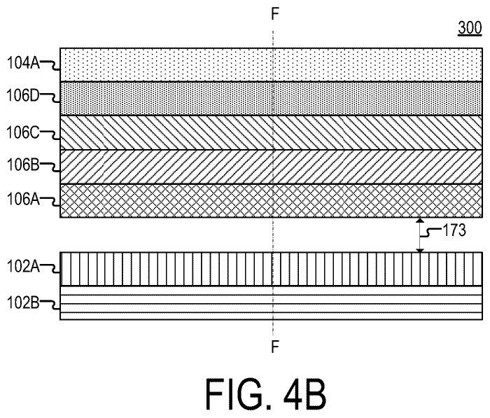

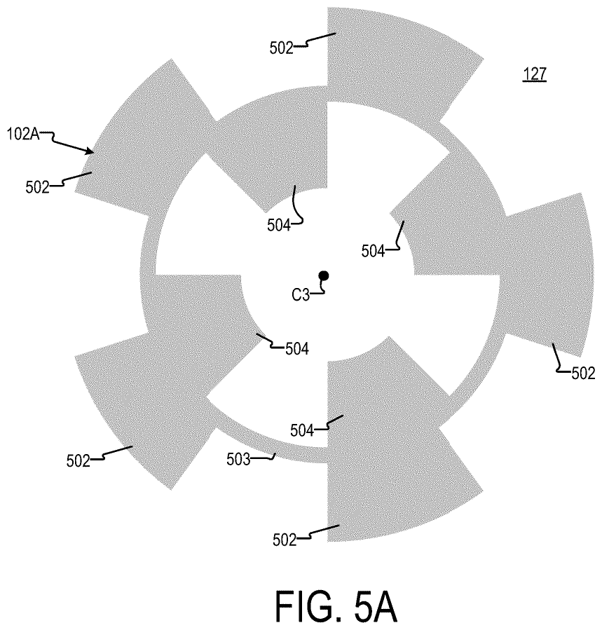

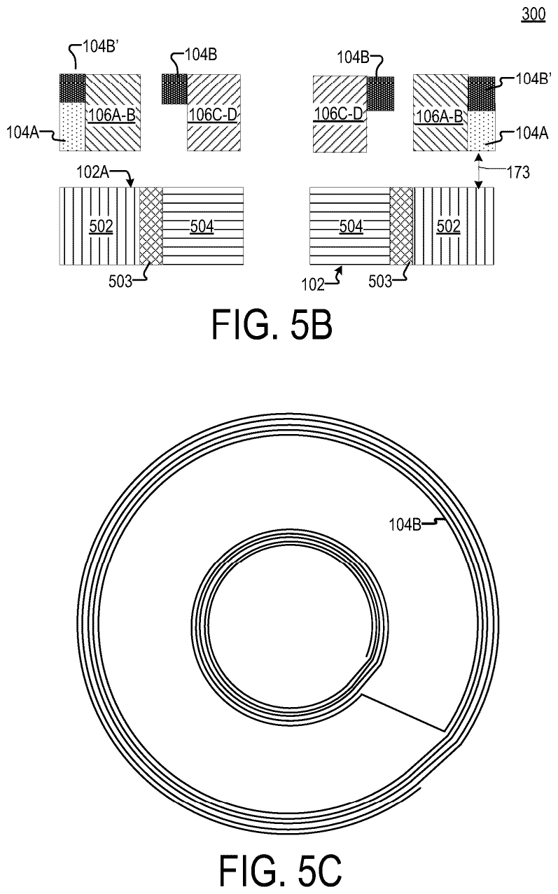

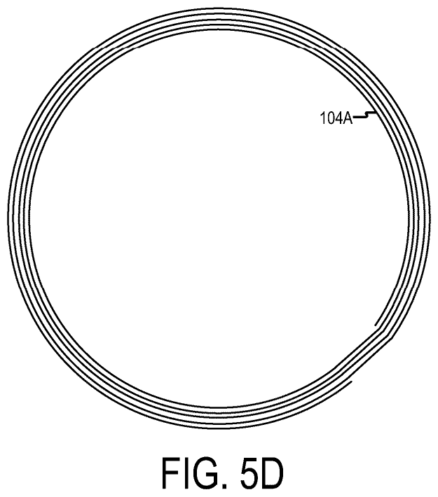

The target set 102 may assume one of a plurality of different configurations, which are herein referred to as configuration 123 (FIG. 3A), configuration 125 (FIG. 4A), and configuration 127 (FIG. 5A). In configuration 123, target set 102 may include targets 102A and 102B which are arranged in a concentric configuration. In configuration 123, each of targets 102A and 102B may include a single set of teeth. Configuration 123 is discussed further below with respect to FIG. 3A.

In configuration 125, target set 102 may include targets 102A and 102B which are arranged in a stacked configuration. In configuration 125, each of targets 102A and 102B may include a single set of teeth. Configuration 125 is discussed further below with respect to FIG. 4A. In configuration 127, target set 102 may include only target 102A. In configuration 127, target 102A may include two different sets of teeth. Configuration 127 is discussed further below with respect to FIG. 5A.

When target set 102 is configured in accordance with configurations 123 and 125, transmitting coil 104A may generate a first magnetic field. The first magnetic field may induce first eddy currents in the target 102A. The first eddy currents may result in a first magnetic field (hereinafter “first reflected field”) being emitted from the target 102A. The receiving coils 106A and 106B may sense the first reflected field and generate magnetic field signals 107A and 107B in response to the first reflected field. The transmitting coil 104B may generate a second magnetic field. The second magnetic field may induce second eddy currents in the target 102B. The second eddy currents may result in a second magnetic field (hereinafter “second reflected field”) being emitted from the target 102B. The receiving coils 106C and 106D may sense the second reflected field and generate magnetic field signals 107C and 107D in response to the second reflected field. The sensor 108 may receive the signals 107A-D and generate an output signal Sout based on the signals 107A-D.

When target set 102 is configured in accordance with configuration 127, transmitting coil 104A may generate a first magnetic field. The first magnetic field may induce first eddy currents in the first set of teeth of target 102A (e.g., see teeth 502 shown in FIG. 5B) and second eddy currents in the second set of teeth of target 102A (e.g., see teeth 504 shown in FIG. 5B). The first eddy currents may result in a first magnetic field (hereinafter “first reflected field”) being emitted from a first set of teeth of target 102A. The receiving coils 106A and 106B may sense the first reflected field and generate magnetic field signals 107A and 107B in response to the first reflected field. The second eddy currents may result in a second magnetic field (hereinafter “second reflected field”) being emitted from a second set of teeth of target 102A. The receiving coils 106C and 106D may sense the second reflected field and generate magnetic field signals 107C and 107D in response to the second reflected field. The sensor 108 may receive the signals 107A-D and generate the output signal Sout based on the signals 107A-D. In the example of FIG. 5B, transmitting coil 104B includes two concentric loops, wherein one of the concentric loops disposed over teeth 502 and the other concentric loop is disposed over teeth 504. A top-down view of transmitting coil 104B, in accordance with this implementation, is provided in FIG. 5C. Furthermore, in the example of FIG. 5B, transmitting coil 104A may include a single loop that is disposed over teeth 502. A top-down view of transmitting coil 104A in accordance with the example of FIG. 5B, is provided in FIG. 5D.

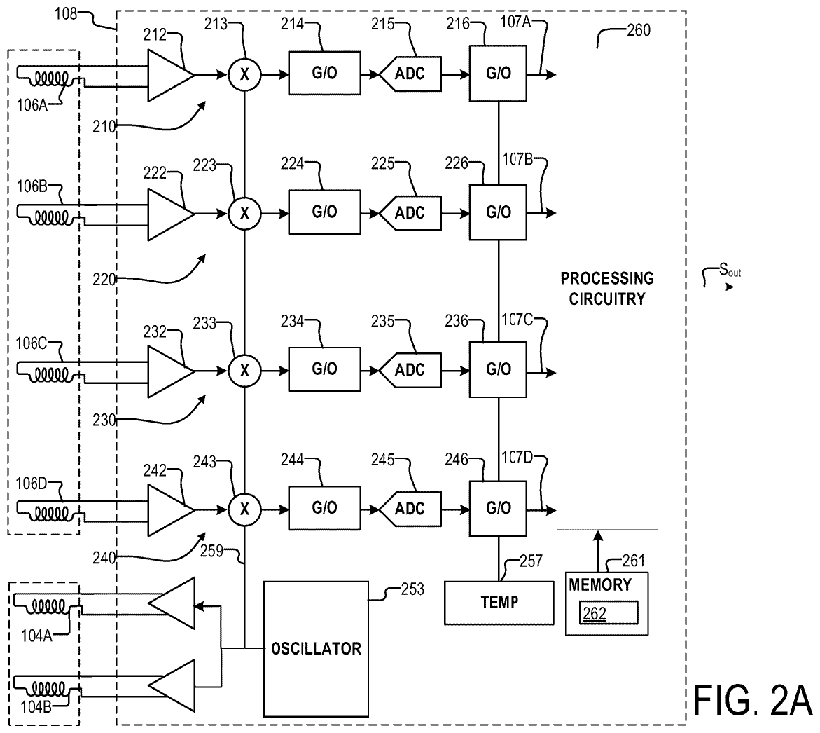

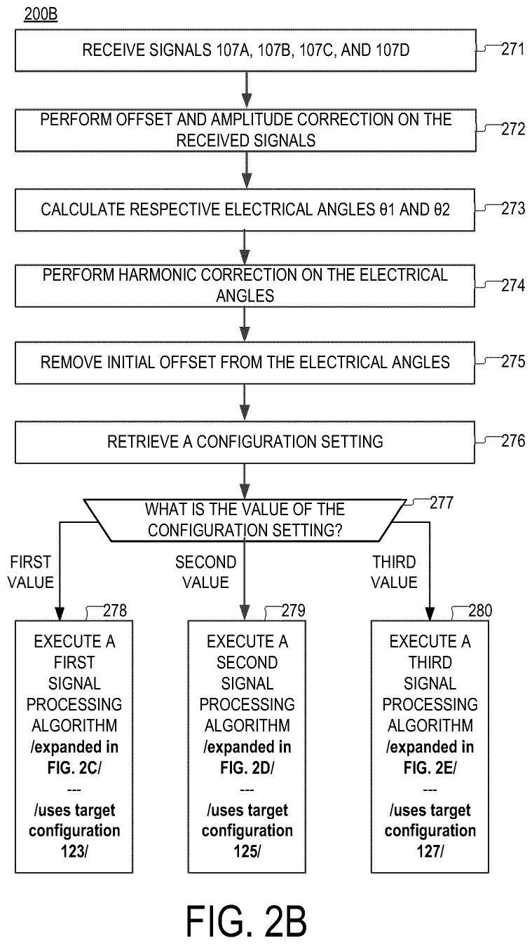

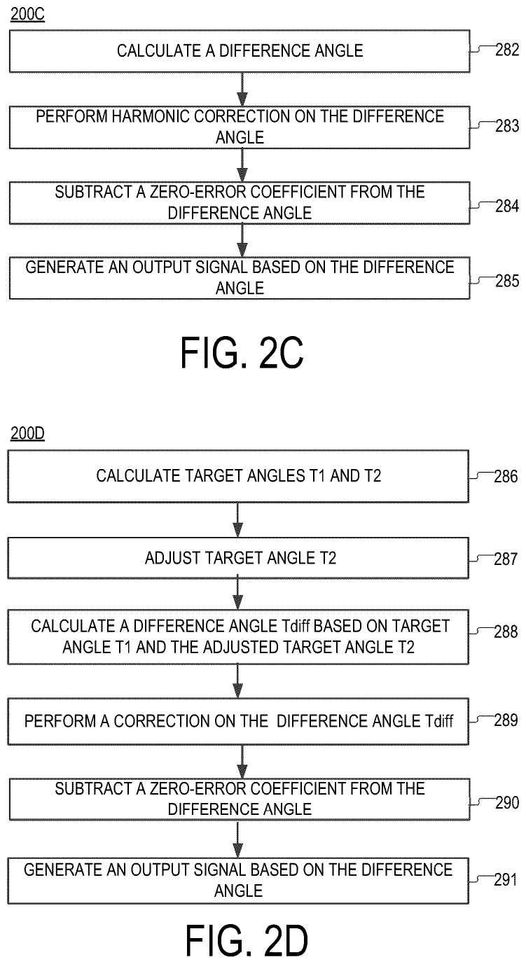

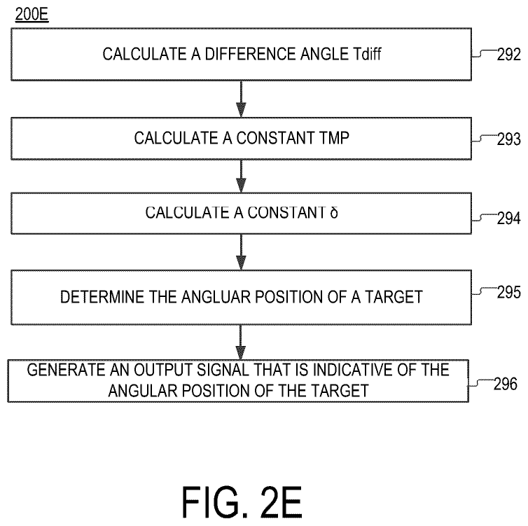

FIG. 2A is a circuit diagram of the sensor 108, according to aspects of the disclosure. As illustrated, sensor 108 may include signal paths 210, 220, 230, and 240, a processing circuitry 260, a memory 261, a temperature sensor 257, and an oscillator 253. Each of the signal paths 210-240 may be coupled to a different one of the receiving coils 106A-D. Each of the signal paths 210-240 may be configured to generate a respective one of signals 107A-D based on the magnetic field signal that is output from a corresponding one of the receiving coils 106A-D.

The processing circuitry 260 may be configured to receive the signals 107A-D and generate the signal Sout based on the signals 107A-D. The processing circuitry 260 may include any suitable type of electronic circuitry. By way of example, the processing circuitry 260 may include one or more of digital logic, a field-programmable gate array, a CORDIC processor, a general-purpose processor, a special-purpose processor, and/or application-specific processing circuitry. In one example, processing circuitry 260 may execute a process 200B, which is discussed further below with respect to FIG. 2B. The signal Sout may be generated as a result of executing process 200B. According to the present example, memory 261 includes a read-only memory. However, alternative implementations are possible in which memory 261 includes any suitable type of volatile or non-volatile memory, such as random-access memory, a flash memory, or an Electrically-Erasable Programmable Read-Only Memory (EEPROM). It will be understood that the present disclosure is not limited to any specific implementation of memory 261.

Processing circuitry 260 may be configured to execute three different signal processing algorithms for the determination of torque or position. However, processing circuitry 260 may be limited to executing only one of those signal processing algorithms depending on the value of a configuration setting 262 that is stored in memory 261. Configuration setting 262 may include any suitable number, string, or alphanumerical string. If the configuration setting 262 is set to a first value, processing circuitry 260 may execute a first signal processing algorithm, which is discussed further below with respect to FIG. 2C. If the configuration setting 262 is set to a second value, processing circuitry 260 may execute a second signal processing algorithm, which is discussed further below with respect to FIG. 2D. And if the configuration setting 262 is set to a third value, processing circuitry 260 may execute a third signal processing algorithm, which is discussed further below with respect to FIG. 2E.

In some implementations, each of the first, second, and third signal processing algorithms may be preferably used in conjunction with a different target configuration. The first signal processing algorithm may be preferably used when target set 102 is configured in accordance with configuration 123. The first signal processing algorithm may be used to determine torque. The second signal processing algorithm may be preferably used when target set 102 is configured in accordance with configuration 125. The second signal processing algorithm may be used to determine torque. The third signal processing algorithm may be preferably used when target set 102 is configurated in accordance with configuration 127. The third signal processing algorithm may be used to determine angular position.

The value of configuration setting 262 may be set in the factory. Using configuration setting 262 may allow the same generic device to be differentiated into three different part numbers depending on the desired functionality. In this way, the same device can be manufactured in large numbers, at an increased efficiency, after which configuration setting 262 may be used to limit the function of each device to fit into a particular market niche (and/or fit to a particular target set configuration).

The oscillator 253 may be configured to drive the transmitting coils with a signal 259. Although in the example of FIG. 2A the oscillator 253 is configured to drive two different transmitting coils, alternative implementations are possible in which the oscillator 253 is configured to drive only one transmitting coil or a different number of transmitting coils.

Signal path 210 may include an amplifier 212, a demodulator 213, a first gain/offset adjustment circuit 214, an analog-to-digital converter (ADC) 215, and a second gain/offset adjustment circuit 216. In operation, receiving coil 106A may generate a magnetic field signal in response to the first reflected magnetic field, which is discussed above with respect to FIG. 1. The receiving coil 106A may provide the magnetic field signal to the amplifier 212. The amplifier 212 may amplify the magnetic field signal and provide the amplified signal to the demodulator 213. The demodulator 213 may demodulate the magnetic field signal, based on signal 259, and provide the demodulated signal to the first gain/offset adjustment circuit 214. The first gain/offset adjustment circuit 214 may adjust the gain and/or offset of the demodulated signal and provide the adjusted signal to ADC 215. ADC 215 may digitize the demodulated signal and provide the digitized signal to the second gain/offset adjustment circuit 216. The second gain/offset adjustment circuit 216 may adjust the gain and/or offset of the digitized signal based on a signal provided by temperature sensor 257 and generate the signal 107A as a result.

Signal path 220 may include an amplifier 222, a demodulator 223, a first gain/offset adjustment circuit 224, an analog-to-digital converter (ADC) 225, and a second gain/offset adjustment circuit 226. In operation, receiving coil 106B may generate a magnetic field signal in response to the first reflected magnetic field. The receiving coil 106B may provide the magnetic field signal to the amplifier 222. The amplifier 222 may amplify the magnetic field signal and provide the amplified signal to the demodulator 223. The demodulator 223 may demodulate the magnetic field signal, based on signal 259, and provide the demodulated signal to the first gain/offset adjustment circuit 224. The first gain/offset adjustment circuit 224 may adjust the gain and/or offset of the demodulated signal and provide the adjusted signal to ADC 225. ADC 225 may digitize the demodulated signal and provide the digitized signal to the second gain/offset adjustment circuit 226. The second gain/offset adjustment circuit 226 may adjust the gain and/or offset of the digitized signal based on a signal provided by temperature sensor 257 and generate the signal 107B as a result.

Signal path 230 may include an amplifier 232, a demodulator 233, a first gain/offset adjustment circuit 234, an analog-to-digital converter (ADC) 235, and a second gain/offset adjustment circuit 236. In operation, receiving coil 106C may generate a magnetic field signal in response to the second reflected magnetic field, which is discussed above with respect to FIG. 1. The receiving coil 106C may provide the magnetic field signal to the amplifier 232. The amplifier 232 may amplify the magnetic field signal and provide the amplified signal to the demodulator 233. The demodulator 233 may demodulate the magnetic field signal, based on signal 259, and provide the demodulated signal to the first gain/offset adjustment circuit 234. The first gain/offset adjustment circuit 234 may adjust the gain and/or offset of the demodulated signal and provide the adjusted signal to ADC 235. ADC 235 may digitize the demodulated signal and provide the digitized signal to the second gain/offset adjustment circuit 236. The second gain/offset adjustment circuit 236 may adjust the gain and/or offset of the digitized signal based on a signal provided by temperature sensor 257 and generate the signal 107C as a result.

Signal path 240 may include an amplifier 242, a demodulator 243, a first gain/offset adjustment circuit 244, an analog-to-digital converter (ADC) 245, and a second gain/offset adjustment circuit 246. In operation, receiving coil 106D may generate a magnetic field signal in response to the second reflected magnetic field. The receiving coil 106D may provide the magnetic field signal to the amplifier 242. The amplifier 242 may amplify the magnetic field signal and provide the amplified signal to the demodulator 243. The demodulator 243 may demodulate the magnetic field signal, based on signal 259, and provide the demodulated signal to the first gain/offset adjustment circuit 244. The first gain/offset adjustment circuit 244 may adjust the gain and/or offset of the demodulated signal and provide the adjusted signal to ADC 245. ADC 245 may digitize the demodulated signal and provide the digitized signal to the second gain/offset adjustment circuit 246. The second gain/offset adjustment circuit 246 may adjust the gain and/or offset of the digitized signal based on a signal provided by temperature sensor 257 and generate the signal 107D as a result.

FIG. 2A is provided to illustrate an example of one possible sensor architecture that can be used to execute process 200B, which is discussed further below. It will be understood that the present disclosure is not limited to any specific configuration of sensor 108. For example, in some implementations, any of elements 212-216, 222-226, 232-236, and 242-246 may be omitted, in which case only the adjustments discussed further below with respect to FIG. 2B would be performed. In this regard, it will be understood that signal 107A may be any signal that is produced in response to a first magnetic field, wherein the first magnetic field is generated by a first set of target teeth. Signal 107B may be any signal that is at least in part generated in response to the first magnetic field. Signal 107C may be any signal that is that is at least in part generated in response to a second magnetic field, wherein the first magnetic field is generated by a second set of target teeth. Signal 107D may be any signal that is at least in part generated in response to the second magnetic field. As noted above, depending on the configuration of target set 102, the first and second sets of target teeth may be part of different targets, or they may be integrated into the same target.

FIG. 2B is a diagram of an example of a process 200B, according to aspects of the disclosure.

At step 271, processing circuitry 260 receives signals 107A, 107B, 107C, and 107D.

At step 272, processing circuitry 260 performs offset and amplitude correction on each of the received signals 107A, 107B, 107C, and 107D. In some implementations, processing circuitry may calculate a different respective offset adjustment coefficient for each of signals 107A, 107B, 107C, and 107D. Furthermore, processing circuitry 260 may calculate a different respective gain adjustment coefficient for each of signals 107A, 107B, 107C, and 107D. Afterwards, processing circuitry 260 may adjust each of the signals 107A, 107B, 107C, and 107D based on the respective gain and offset adjustment coefficients that are calculated for that signal. Specifically, the gain and offset of each of signals 107A, 107B, 107C, and 107D may be corrected in accordance with the equation of:

$${y}_{c} = \frac{y - {O}_{y}}{{A}_{y}} \qquad ( 1.1 )$$

where y is any given one of signals 107A, 107B, 107C, and 107D, O_{y} is the respective offset adjustment coefficient for the given signal, A_{y} is the respective gain adjustment coefficient for the given signal, and y_{c} is the value of the given signal after the gain and offset adjustment is performed.

In some implementations, the respective gain and offset adjustment coefficients for each of signals 107A, 107B, 107C, and 107D may be calculated by monitoring the peaks and troughs of the signal and identifying the maximum and minimum of the signal. The maximum of the signal may be the largest value of the signal (i.e., the value of the highest peak in the signal) that is detected in the period for which the signal is monitored. The minimum of the signal may be the smallest value of the signal (i.e., the value of the lowest through in the signal) that is detected in the period for which the signal is monitored. Specifically, the respective offset and gain adjustment coefficient for any given one of signals 107A, 107B, 107C, and 107D may be calculated by using equations 2-3 below:

$${A}_{y} = \frac{max ( y ) - min ( y )}{2} \qquad ( 2 )$$

$${O}_{y} = \frac{max ( y ) + min ( y )}{2} \qquad ( 3 )$$

where y is any given one of signals 107A, 107B, 107C, and 107D, O_{y} is the respective offset adjustment coefficient for the given signal, A_{y} is the respective gain adjustment coefficient for the given signal, max (y) is the maximum value of the given signal, and min (y) is the minimum of the given signal.

At step 273, processing circuitry 260 calculates electrical angles θ1 and θ2 for the target. According to the present example, the electrical angles are calculated in accordance with equations 4A and 4B below:

$$θ1 = a tan ( \frac{{s}_{107 A}}{{s}_{107 B}} ) \qquad ( 4 A )$$

$$θ2 = a tan ( \frac{{s}_{107 C}}{{s}_{107 D}} ) \qquad ( 4 B )$$

where S_{107A} is signal 107A, S_{107B} is signal 107B, S_{107c} is signal 107C and S_{107D} is signal 107D.

In some implementations, after the values of θ1 and θ2 are determined, processing circuitry 260 may perform harmonic correction on each (or at least some) of signals 107A-D. The harmonic connection may be performed in accordance with equation 1 below:

$$correctedSignal = s + {\sum }_{k = 1}^{n} {a}_{k} sin ( k * angle + {φ}_{k} ) \qquad ( 1 )$$

where s is the signal that is being corrected, aₖ is the k-th order harmonic amplitude, and φₖ is the k-th order harmonic phase, and angle is an electrical angle that is calculated on signal s (i.e., θ1 when the s is one of signals 107A-B and θ2 when s is one of signals 107C-D). In some implementations, the values of aₖ and φₖ can be determined either by simulation or by calibration that is performed on sensor 108 after sensor 108 is installed in a particular system.

At step 274, processing circuitry 260 performs harmonic compensation on electrical angles θ1 and θ2. The harmonic compensation of any given one of electrical angles θ1 and θ2 can be performed in accordance with equation 5 below.

$$angleOut = a - ( {HA}_{1} * sin ( a + {HP}_{1} ) + {HA}_{2} * sin ( 2 * a + {HP}_{2} ) + {HA}_{3} * sin ( 3 * a + {HP}_{3} ) + {HA}_{4} * sin ( 4 * a + {HP}_{4} ) ) = a - {\sum }_{i = 1}^{k} {HA}_{i} * sin ( i * a + {HP}_{i} ) \qquad ( 5 )$$

where angleOut is the compensated angle, a is the value of the electrical angle that is being compensated to produce angleOut, HAᵢ is the i-th order harmonic amplitude, HP; is the i-th order harmonic phase, and is an integer having a value between 1 and 4. According to the present example, the integer k is equal to 4. However, the present disclosure is not limited to k having any specific value. In some implementations, the values of HA and HP can be determined either by simulation or by calibration that is performed on sensor 108 after sensor 108 is installed in a particular system. In some implementations, the values of electrical angles θ1 and θ2 can be recalculated based on the values of signals 107A-D that result after harmonic correction is performed based on each (or at least some) of signals 107A-D.

At step 275, processing circuitry 260 removes an initial offset from electrical angles θ1 and θ2. The removal of the initial offset is performed on the values of electrical angles θ1 and θ2 that result after the performance of harmonic compensation (at step 274). In some implementations, the initial offset may be removed in accordance with equation 6 below:

$$angleOut = angle - zeroAngle \qquad ( 6 )$$

where angleOut is the value of the adjusted electrical angle, angle is the value of the electrical angle that is being adjusted, and zeroAngle is the angle offset between the measured angle and a reference electrical angle. In some implementations, the value of zeroAngle can be determined either by simulation or by calibration that is performed on sensor 108 after sensor 108 is installed in a particular system.

At step 276, processing circuitry 260 retrieves configuration setting 262 from memory 261.

At step 277, processing circuitry 260 determines the value of configuration setting 262. If configuration setting 262 is set to a first value, process 200B proceeds to step 278. If configuration setting 262 is set to a second value, process 200B proceeds to step 279. And if configuration setting 262 is set to a third value, process 200B proceeds to step 280.

At step 278, processing circuitry 260 executes a first signal processing algorithm. As noted above, the first signal processing algorithm may be preferably used when target set 102 is configured in accordance with configuration 123 (shown in FIG. 3A). Executing the first signal processing algorithm may result in processing circuitry 260 generating an indication of a torque that is imparted on a mechanical system or element including targets 102A and 102B. The first signal processing algorithm is discussed further below with respect to FIG. 2C.

At step 279, processing circuitry 260 executes a second signal processing algorithm. As noted above, the second signal processing algorithm may be preferably used when target set 102 is configured in accordance with configuration 125 (shown in FIG. 4A). Executing the second signal processing algorithm may result in processing circuitry 260 generating an indication of a torque that is imparted on a mechanical system or element including targets 102A and 102B. The second signal processing algorithm is discussed further below with respect to FIG. 2D.

At step 280, processing circuitry 260 executes a third signal processing algorithm. As noted above, the third signal processing algorithm may be preferably used when target set 102 is configured in accordance with configuration 127 (shown in FIG. 5A). Executing the third signal processing algorithm may result in processing circuitry 260 generating an indication of the angular position of target 102A and/or a mechanical element attached to target 102A. The third signal processing algorithm is discussed further below with respect to FIG. 2E.

FIG. 2C is a diagram of an example of a process 200C for executing a first signal processing algorithm, as specified by step 278 of process 200B.

At step 282, processing circuitry 260 calculates a difference angle. The difference angle is the difference between electrical angles θ1 and θ2. According to the present example, the difference angle is calculated based on the values of θ1 and θ2 after harmonic compensation and offset adjustment is performed on each of those values at steps 274 and 275, respectively. In some implementations, the difference angle may be calculated based on equation 7 below:

$$diffAngle = θ 1 - θ 2 \qquad ( 7 )$$

where diffAngle is the difference angle.

At step 283, processing circuitry 260 performs harmonic correction on the difference angle. In some implementations, the harmonic correction may be performed in accordance with equation 8 below:

$$diffAngle = diffAngle - {\sum }_{i = 1}^{k} {A}_{i} * sin ( i * diffAngle + {P}_{i} ) \qquad ( 8 )$$

where diffAngle, is the difference angle determined at step 282, Aᵢ is the i-th order harmonic amplitude of the difference angle, and Pᵢ is the i-th order harmonic phase of the difference angle. In some implementations, processing circuitry may also perform harmonic compensation on signals 107A-D, in the manner discussed above.

At step 284, processing circuitry 260 subtracts a zero-error coefficient from the difference angle. According to the present example, the zero-error coefficient is subtracted from the value of the difference angle that results after harmonic compensation is performed on the difference angle. In some implementations, the zero-error coefficient may be subtracted in accordance with equation 9 below:

$$diffAngle = diffAngle - zeroError \qquad ( 9 )$$

where diffAngle is the value of the difference angle that results after harmonic compensation is performed at step 283 on the difference angle, and zeroError is the zero-error coefficient of the difference angle. In some implementations, the value of zeroError can be determined either by simulation or by calibration that is performed on sensor 108 after sensor 108 is installed in a particular system.

At step 285, processing circuitry 260 generates the output signal Sout (shown in FIG. 2). The output signal Sout may be any signal that is at least in part generated based on the value of the corrected difference angle (i.e., the value produced as a result of executing step 284).

As noted above, preferably, process 200C may be executed when target set 102 is configured in accordance with configuration 123. FIG. 3A shows an example of target set 102 when target set 102 is configured in accordance with configuration 123. As illustrated, when in configuration 123, target set 102 may include a target 102A and a target 102B. Target 102A may be disposed in an opening 301 in target 102A. Target 102A may include teeth 304 that are separated by valleys 306 and coupled to a band 302. Target 102B may include teeth 314 that are separated by valleys 316 and coupled to a band 312. Target 102A may have a radius R1 and target 102B may have a radius R2 that is smaller than the radius R1. Although, in the example of FIG. 3A, targets 102A-B include bands 302 and 312, alternative implementations are possible in which the bands are omitted. In such implementations, the teeth 304 and 314 may be formed on a plastic substrate or a substrate made of another material (e.g., another dielectric material). In some implementations, the targets 102A-B may be formed of metal and/or any other electrically conductive material. For the purpose of the present disclosure, the terms “teeth” and “conductive features” are considered to be synonymous when used in the context of a target. For ease of description, elements 304 and 314 are referred to as teeth when bands 302 and 312 are omitted.

FIG. 3B shows a side view of assembly 300, when target set 102 is configured in accordance with configuration 123. In the example of FIG. 3B, target 102B is disposed in an opening 301 in target 102A. Receiving coils 106A-B and transmitting coil 104A may be disposed directly above target 102A. Receiving coils 106B-C and transmitting coil 104B may be disposed directly above target 102B. An air gap 173 may be present between targets 102A-B and coils 106A-D and 104A-D. FIG. 3B is provided to illustrate that receiving coils 106A-B and transmitting coil 104A may be aligned with target 102A, so that transmitting coil 104A would be able to excite target 102A and receiving coils 106A-B would be able to receive the reflected magnetic field produced by the set of teeth 304. FIG. 3B is further provided to illustrate that receiving coils 106C-D and transmitting coil 104B may be aligned with target 102B so that transmitting coil 104B would be able to excite target 102B and receiving coils 106C-D would be able to receive the reflected magnetic field produced by the set of teeth 314.

The present disclosure is not limited to the example of FIGS. 3A-B. It will be understood that the present disclosure is not limited to any specific relative arrangement of targets 102A-B and/or coils 106A-B and 104A-B. In some implementations, each of targets 102A-B, receiving coils 106A-D, and transmitting coils 104A-B may be disposed above or below any of the remaining ones of targets 102A-B, receiving coils 106A-D, and transmitting coils 104A-B. Examples of further possible implementations of configuration 123 and/or assembly 300 can be found in U.S. patent application Ser. No. 18/354,895, entitled Position Sensing Method and System, filed on Jul. 19, 2023, and having attorney docket number ALLEG-A040PUS of which the present application is a continuation-in-part.

In some implementations, target 102A may be coupled to a first shaft (e.g., a lower shaft) and target 102B may be coupled to a second shaft (e.g., an upper shaft), where the first shaft and the second shaft are part of a steering column or another mechanical assembly. In such implementations, the value of signal Sout (determined at step 285) may be indicative of the torque that is being applied to the steering column or other mechanical assembly. Specifically, as torque is applied to the drive shaft or other mechanical assembly, target 102A may rotate relative to target 102B (or vice versa). The value of the difference angle (calculated at steps 282-285) may measure the relative displacement between targets 102A-B, and as such it may be indicative of the torque that is being applied to the steering column or other mechanical assembly. Alternatively, in some implementations, targets 102A-B may be coupled to different ends of the same torsion bar used to measure the torque that is being applied to the torsion bar. In some implementations, the torsion bar may be an integral rod, and thus, in some implementations, targets 102A-B may be coupled to parts of the same mechanical element that are integral with each other.

Although not required, in some implementations, the value of signal Sout may incorporate information about the rigidity of the elements coupled to targets 102A-B, as well as the rigidity of their mechanical linkage, to provide a more accurate assessment of torque. By way of example, and without limitation, the value of the output signal may be calculated by using a simple linear function (e.g., output_signal=A*diffAngle+B), where the values of the slope A and offset B reflect the mechanical properties of the system and are determined experimentally or analytically. Alternatively, the value of the difference angle may itself be treated as a measure of torque. In some implementations, the signal Sout may encode the difference angle alone (obtained at step 284) into a specific digital or analog format.

In some implementations, the zero-error coefficient used in equation 9 may be the relative displacement of targets 102A and 102B that would be measured when no torque is being applied to the steering column or other mechanical assembly. The zero-angle value may be stored in memory 261 at the factory or when sensor 108 is calibrated. The zero-angle value may be retrieved from memory 261 when equation 9 is evaluated.

FIG. 2D is a diagram of an example of a process 200D for executing a second signal processing algorithm, as specified by step 279 of process 200B.

At step 286, processing circuitry 260 calculates target angles T1 and T2. According to the present example, target angle T1 is calculated by dividing the electrical angle θ1 by the number of teeth that are present in target 102A and target angle T2 is calculated by dividing the electrical angle θ2 by the number of teeth that are present in target 102B. It will be recalled that the value of electrical angle θ1 is calculated based on signals 107A-B, which are generated in response to a reflected magnetic field that is produced by target 102A. It will be further recalled, that the value of electrical angle θ2 is calculated based on signals 107C-D, which are generated in response to a reflected magnetic field that is produced by target 102B. In some implementations, target angles T1 and T2 may be calculated based on equations 10 and 11 below:

$$T 1 = θ1 / {N}_{1} \qquad ( 10 )$$

$$T 2 = θ2 / {N}_{2} \qquad ( 11 )$$

where N₁ is the number of teeth that is present in target 102A and N₂ is the number of teeth that is present in target 102B.

At step 287, processing circuitry 260 adjusts target angle T2 to produce a target angle T2mod. In some implementations, the modified target angle T2mod may be calculated by wrapping the target angle in accordance with the following algorithm:

$$T {2}_{mod} = T 2$$

$$if$$

$$( T 2 > 180 / {N}_{1} )$$

$$T {2}_{mod} = T 2 - 180 / ( {N}_{1} / a )$$

$$else if$$

$$( T 2 < - 180 / {N}_{1} )$$

$$T {2}_{mod} = T 2 + 180 / ( {N}_{1} / a )$$

As illustrated, the algorithm considers whether the value of angle θ2 is greater than a first quotient of 180 and the number N₁ of teeth in target 102A. If the value of angle T2 is equal to the first quotient, the adjusted angle T2mod is set to equal the value of angle θ2. If the value of angle T2 is greater than the first quotient, the value of T2_{mod} is set to equal the difference between the value of angle T2 and a second quotient of 180 and the number N₁ of teeth in the target 102A divided by the factor a. If the value of the angle T2 is smaller than the negative of the first quotient, T2_{mod} is set to equal the sum of T2 and the second quotient. According to the present example, factor a has the value of ‘2’ (i.e., a=2). According to the present example, the value of a is equal to the quotient of N1 and N2 (i.e., a=N1/N2). The algorithm used at step 287 assumes that N₁ is smaller than N₂ (i.e., N₁<N₂).

At step 288, processing circuitry 260 calculates a difference angle Tdiff based on the angle T1 and the angle T2mod. According to the present example, the difference angle Tdiff is calculated in accordance with equation 12 below:

$$Tdif = T 1 - T {2}_{mod} \qquad ( 12 )$$

At step 289, processing circuitry 260 performs a correction on the difference angle Tdiff to generate a corrected angle Tcor. According to the present example, the corrected angle is calculated by wrapping the difference angle Tdiff. Specifically, in some implementations, the corrected angle Tcor may be calculated by using the following algorithm:

$$Tcor = Tdif$$

$$if$$

$$( Tdif > 180 / {N}_{1} )$$

$$Tcor = Tdiff - 360 / {N}_{1}$$

$$else if$$

$$( Tdif < - 180 / {N}_{1} )$$

$$Tcor = Tdiff + 360 / {N}_{1}$$

As illustrated, the algorithm considers whether the value of angle Tdiff is greater than a first quotient of 180 and the number N₁ of teeth in target 102A. If the value of angle Tdiff is equal to the first quotient, the corrected angle Tcor is set to equal the value of the difference angle Tdiff. If the value of angle Tdiff is greater than the first quotient, the value of Tdiff is set to equal the difference between the value of angle Tdiff and a second quotient of 360 and the number N₁ of teeth in the target 102A. If the value of Tdiff is smaller than the negative of the first quotient, the value of Tcor is set to equal the sum of Tdiff and the second quotient. The algorithm used at step 287 assumes that N₁ is smaller than N₂ (i.e., N₁<N₂).

At step 290, processing circuitry 260 subtracts a zero-error coefficient from the corrected angle Tcor. In some implementations, the zero-error coefficient may be subtracted in accordance with equation 13 below:

$$Tcor = Tcor = zeroError \qquad ( 13 )$$

where zeroError is the zero-error coefficient of the difference angle.

At step 291, processing circuitry 260 generates the output signal Sout (shown in FIG. 2). The output signal Sout may be any signal that is at least in part generated based on the value of the corrected angle Tcor which is produced as a result of executing step 290.

As noted above, preferably, process 200D may be executed when target set 102 is configured in accordance with configuration 125. FIG. 4A shows an example of target set 102 when target set 102 is configured in accordance with configuration 125. As illustrated, when in configuration 125, target set 102 may include a target 102A and a target 102B. Target 102A may include a band 412 and a plurality of teeth 414 that is coupled to band 412 and separated by valleys 416. Target 102B may include a band 422 and a plurality of teeth 424 that is coupled to band 422 and separated by valleys 426. According to the present example, target 102A includes N1 teeth and target 102B includes N2 teeth, where N1 and N2 are integer numbers and N1>N2.

According to the present example, the bands 412 and 422 have a circular shape and they are centered on axis F-F. However, alternative implementations are possible in which the bands 412 and 422 have a different shape, such as a linear shape, a rectangular shape, an oval shape, or an arch shape. Although, in the example of FIG. 4A, targets 102A-B include bands 412 and 422, alternative implementations are possible in which the bands are omitted. In such implementations, the teeth 414 and 424 may be formed on a plastic substrate or a substrate made of another material (e.g., another dielectric material). In some implementations, the targets 102A-B may be formed of metal and/or any other electrically conductive material.

FIG. 4B shows a side view of assembly 300, when target set 102 is configured in accordance with configuration 125. In the example of FIG. 4B, target 102A is positioned over target 102B. Receiving coil 106A is disposed above target 102A. Receiving coil 106B is disposed above receiving coil 106A. Receiving coil 106C is disposed above receiving coil 106B. Receiving coil 106D is disposed above receiving coil 106C. Transmitting coil 104A is disposed above receiving coil 106D. In the example of FIG. 4B, transmitting coil 104B is omitted and transmitting coil 104A is used to excite both of targets 102A-B. An air gap 173 may be present between targets 102A-B and the receiving and transmitting coils 106A-D and 104A. It will be understood that the present disclosure is not limited to any is specific relative arrangement of targets 102A-B and/or coils 106A-B and 104A. In some implementations, each of targets 102A-B, receiving coils 106A-D, and transmitting coil 104A may be disposed above or below any of the remaining ones of targets 102A-B, receiving coils 106A-D, and transmitting coil 104A.

The present disclosure is not limited to the example of FIGS. 4A-B. Examples of further possible implementations of configuration 125 and/or assembly 300 can be found in U.S. patent application Ser. No. 18/354,895, entitled Position Sensing Method and System, filed on Jul. 19, 2023, and having attorney docket number ALLEG-A40PUS of which the present application is a continuation-in-part.

In some implementations, target 102A may be coupled to a first shaft (e.g., a lower shaft) and target 102B may be coupled to a second shaft (e.g., an upper shaft), where the first shaft and the second shaft are part of a steering column or another mechanical assembly. In such implementations, the value of signal Sout (determined at step 291) may be indicative of the torque that is being applied to the steering column or other mechanical assembly. Specifically, as torque is applied to the drive shaft or other mechanical assembly, target 102A may rotate relative to target 102B (or vice versa). The value of the difference angle (calculated at steps 286-290) may measure the relative displacement between targets 102A-B, and as such it may be indicative of the torque that is being applied to the steering column or other mechanical assembly. Alternatively, in some implementations, targets 102A-B may be coupled to different ends of the same torsion bar used to measure the torque that is being applied to the torsion bar. In some implementations, the torsion bar may be an integral rod, and thus, in some implementations, targets 102A-B may be coupled to parts of the same mechanical element that are integral with each other.

Although not required, in some implementations, the value of signal Sout may incorporate information about the rigidity of the elements coupled to targets 102A-B, as well as the rigidity of their mechanical linkage, to provide a more accurate assessment of torque. By way of example, and without limitation, the value of the output signal may be calculated by using a simple linear function (e.g., output_signal=A*Tcor+B), where the values of the slope A and offset B reflect the mechanical properties of the system and are determined experimentally or analytically. Alternatively, the value of the difference angle may itself be considered a measure of torque. In some implementations, the signal Sout may encode the difference angle alone (obtained at step 290) into a specific digital or analog format.

In some implementations, the zero-error coefficient used in equation 13 may be the relative displacement of targets 102A and 102B that would be measured when no torque is being applied to the steering column or other mechanical assembly. The zero-angle value may be stored in memory 261 at the factory or when sensor 108 is calibrated. The zero-angle value may be retrieved from memory 261 when equation 13 is evaluated.

FIG. 2E is a diagram of an example of a process 200E for executing a third signal processing algorithm, as specified by step 280 of process 200B. As noted above, process 200E may be executed when target set 102 is configured in accordance with configuration 127. In this configuration, target set 102 may include only one target—i.e., target 102A. The target may include a first set of teeth 502 and a second set of teeth 504 (shown in FIG. 5A). Signals 107A-B may be generated in response to a first reflected magnetic field that is produced by teeth 502. And signals 107C-D may be generated in response to a second reflected magnetic field that is produced by teeth 504.

At step 292, processing circuitry 260 calculates a difference angle by subtracting one of electrical angles θ1 and θ2 from the other. According to the present example, the difference angle is calculated in accordance with equation 14 below.

$$diffAngle = θ 1 - θ 2 \qquad ( 14 )$$

At step 293, processing circuitry 260 calculates the value of a constant tmp. The constant tmp may be calculated by subtracting the product of electrical angle θ2 and the value N2 from the product of electrical angle θ1 and the value N1, where N1 is the number of teeth 502 in target 102A and N2 is the number of teeth 504 that are present in target 102A. It will be recalled that electrical angle θ1 is calculated based on signals 107A-B (shown in FIG. 2), which are generated in response to a reflected magnetic field produced by teeth 502 (e.g., outer band of teeth in target 102A), and electrical angle θ2 is calculated based on signals 107C-D (shown in FIG. 2), which are generated in response to a reflected magnetic field produced by teeth 504 (e.g., inner band of teeth in target 102A). In some implementations, the constant tmp may be calculated in accordance with equation 15 below:

$$tmp = θ1 * {N}_{1} - θ 2 * {N}_{2} \qquad ( 15 )$$

At step 294, processing circuitry 260 calculates the value of a constant δ. According to the present disclosure, constant δ may also be referred to as an adjustment coefficient. According to the present example, the value of constant δ is calculated in accordance with equation 16 below:

$$δ = ( ( ( tmp + 180 ) \%360 ) - 180 ) ( \frac{2}{{N}_{1} + {N}_{2}} ) \qquad ( 16 )$$

At step 295, processing circuitry 260 calculates the angular position of target 102A based on the values of Tdiff, tmp, and δ. In some implementations, the angular position may be calculated in accordance with equation 17 below:

$$abs Angle = ( diffAngle + δ ) \%360 \qquad ( 17 )$$

where absAnlge is the angular position of target 102A.

At step 296, processing circuitry 260 generates the output signal Sout (shown in FIG. 2A). The output signal Sout may be any signal that is at least in part generated based on the value absAngle that is determined at step 295. In one example, the signal Sout may be a digital signal that encodes (or is equal to) the value absAngle. In another example, the value of signal Sout may be a voltage signal whose level is proportional to the value of absAngle. In any event, the value of signal Sout may be indicative of the angular position of target 102A. After the value of signal Sout is generated, signal Sout may be provided to an external controller and/or a communications interface of sensor 108 (not shown).

As noted above, preferably, process 200E may be executed when target set 102 is configured in accordance with configuration 127. FIG. 5A shows an example of target set 102 when target set 102 is configured in accordance with configuration 127. As illustrated, when in configuration 127, target set 102 may include a target 102A. Target 102A may include a band 503, a set of outer teeth 502 that are coupled to band 503, and a set of inner teeth 504 that are also coupled to band 503. According to the present example, band 503 is shaped as a circular ring having a center C3. However, the present disclosure is not limited to any specific shape of band 503. Each of the teeth 502 and 504 may be shaped as the sector of a ring. However, the present disclosure is not limited to any specific shape for teeth 504 and 502.

According to the present example, the set of inner teeth 504 includes fewer teeth than the set of outer teeth 502. However, alternative implementations are possible in which the set of teeth 504 includes a greater number of teeth than the set of teeth 502. Although, in the present example, teeth 504 have a smaller width (and/or size) than teeth 502, alternative implementations are possible in which at least one of features 504 has a greater width (and/or size) than one or more teeth 502.

In one example, target 102A may be formed of metal and/or any other electrically conductive material. Additionally or alternatively, in some implementations, target 102A may be formed by stamping a sheet of metal or other conductive material. In such implementations, teeth 502 and band 503 may be integral with each other, such that target 102A is a monolithic piece of metal (or a monolithic piece of another suitable material). Additionally or alternatively, in some implementations, target 102A may be formed by using a lithographic technique to pattern the shape of target 102A out of a metal layer that is formed on a substrate. In such implementations, target 102A may be implemented as a printed circuit board (PCB) rather than a standalone conductive structure.

FIG. 5B shows a cross-sectional side view of assembly 300, when target set 102 is configured in accordance with configuration 127. In the example of FIG. 5B, receiving coils 106A-B and transmitting coil 104A may be disposed directly above the set of outer teeth 502. Receiving coils 106C-D and transmitting coil 104B may be disposed directly above the set of inner teeth 504. An air gap 173 may be present between target 102A and coils 106A-D and 104A-B. FIG. 5B is provided to illustrate that receiving coils 106A-B and transmitting coil 104A may be aligned with the set of outer teeth 502 so that transmitting coil 104A would be able to excite the outer teeth 502 of target 102A, and receiving coils 106A-B would be able to receive the reflected magnetic field produced by the set of teeth 502. FIG. 5B is further provided to illustrate that receiving coils 106C-D and transmitting coil 104B may be aligned with the set of inner teeth 504 so that transmitting coil 104B would be able to excite target 102B, and receiving coils 106C-D would be able to receive the reflected magnetic field produced by the set of inner teeth 504.

The present disclosure is not limited to the example of FIGS. 5A-B. It will be understood that any of coils 104A-B and 106A-D may be disposed above or below any other one of coils 104A-B and 106A-D, or above or below target 102A. Examples of further possible implementations of configuration 127 and/or assembly 300 can be found in U.S. patent application Ser. No. 18/475,674, entitled Inductive 360-Degree Angle Sensor Using a Radially-Separated Dual Target, filed on Sep. 27, 2023, and having attorney docket number ALLEG-A160PUS of which the present application is a continuation-in-part.

In some implementations, target 102A may be coupled to a shaft or other element. In such implementations, the value of signal Sout (determined at step 296) may be indicative of the position of the shaft or other element. Additionally or alternatively, in some implementations, the value of signal Sout (determined at step 296) may be indicative of the speed of target 102A, acceleration of target 102A, and/or any other characteristic of movement of target 102A. As can be readily appreciated the speed or acceleration may be determined by taking multiple values for the position of target 102A.

In one aspect, process 200E utilizes the Vernier principle to identify the angular position of the target. The Vernier principle takes advantage of the misalignment between the inner set of teeth 504 and the outer set of teeth 502 to arrive at a precise measurement of the angular position of target 102A. In one respect, constant tmp (determined at step 293) represents an encoding of the period (or tooth) index on the lower-count set of teeth. The addition of constant δ to the difference angle (performed at step 295) results in the calculation of the actual angle position of target 102A. In a nutshell, Vernier principle provides that any combination of electrical angles θ1 and θ2, which are measured at the same time, maps uniquely to a specific angular position of target 102A. The difference angle (calculated at step 292) is a representation of that combination, and the coefficient δ (calculated at step 294) represents an offset that is added to the difference to arrive at an exact position measurement. The value δ is a phase corresponding to the period (or tooth) index on the lower set of teeth. As used herein, the phrase “period of a set of teeth” refers to the combination of one tooth in the set and the valley (or other space) that separates this tooth from the next tooth in the set.

The concepts and ideas described herein may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers). Each such program may be implemented in a high-level procedural or object-oriented programming language to work with the rest of the computer-based system. However, the programs may be implemented in assembly, machine language, or Hardware Description Language. The language may be a compiled or an interpreted language, and it may be deployed in any form, including as a stand-alone program or as a module, component, subroutine, or another unit suitable for use in a computing environment. A computer program may be deployed to be executed on one computer or multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, or volatile memory. The term unit (e.g., an addition unit, a multiplication unit, etc.), as used throughout the disclosure may refer to hardware (e.g., an electronic circuit) that is configured to perform a function (e.g., addition or multiplication, etc.), software that is executed by at least one processor, and configured to perform the function, or a combination of hardware and software. As used throughout the disclosure, the term “substantially parallel” shall mean within +/−10 degrees of being exactly parallel. As used throughout the disclosure, the term “approximately 90 degrees off-phase” shall mean within +/−10 degrees of being exactly 90 degrees off-phase.

A magnetic-field sensing element can be, but is not limited to, a Hall Effect element a magnetoresistance element, or an inductive coil. As is known, there are different types of Hall Effect elements, for example, a vertical Hall element, and a Circular Vertical Hall (CVH) element. As is also known, there are different types of magnetoresistance elements, for example, a semiconductor magnetoresistance element such as Indium Antimonide (InSb), a giant magnetoresistance (GMR) element, an anisotropic magnetoresistance element (AMR), a tunneling magnetoresistance (TMR) element, and a magnetic tunnel junction (MTJ). The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

As is known, some of the above-described electromagnetic flux sensing elements tend to have an axis of maximum sensitivity parallel to a substrate that supports the electromagnetic flux sensing element, and others of the above-described electromagnetic flux sensing elements tend to have an axis of maximum sensitivity perpendicular to a substrate that supports the electromagnetic flux sensing element. In particular, planar Hall elements tend to have axes of sensitivity perpendicular to a substrate, while metal based or metallic magnetoresistance elements (e.g., GMR, TMR, AMR) and vertical Hall elements tend to have axes of sensitivity parallel to a substrate.

Having described preferred embodiments, which serve to illustrate various concepts, structures and techniques, which are the subject of this patent, it will now become apparent that other embodiments incorporating these concepts, structures and techniques may be used. Accordingly, it is submitted that the scope of the patent should not be limited to the described embodiments but rather should be limited only by the spirit and scope of the following claims.

1. A system, comprising:
a processing circuitry that is configured to:
receive a signal S1 and a signal S2, the signal S1 being generated by a first receiving coil in response to a first magnetic field, the signal S2 being generated by a second receiving coil in response to the first magnetic field, the signal S2 being approximately 90-degrees off-phase from the signal S1;
receive a signal S3 and a signal S4, the signal S3 being generated by a third receiving coil in response to a second magnetic field, the signal S4 being generated by a fourth receiving coil in response to the second magnetic field, the signal S4 being approximately 90-degrees off-phase from the signal S3;
calculate a first electrical angle based on signals S1 and S2;
calculate a second electrical angle based on signals S3 and S4;
calculate a difference between the first electrical angle and the second electrical angle;
subtract a zero-error coefficient from the difference between the first angle and the second angle to produce a corrected difference; and
output an output signal that is generated at least in part based on the corrected difference.

2. The system of claim 1, wherein the first electrical angle and the second electrical angle are calculated in accordance with the equations of:
$$θ1 = a tan ( \frac{S 1}{S 2} )$$
$$θ2 = a tan ( \frac{S 3}{S 4} )$$
where θ1 is the first electrical angle and θ2 is the second electrical angle.

3. The system of claim 1, wherein the processing circuitry is further configured to perform harmonic compensation on each of the signals S1, S2, S3, and S4, the harmonic compensation being performed in accordance with the equation of:
$$correctedSignal = s + {\sum }_{k = 1}^{n} {a}_{k} sin ( k * angle + {φ}_{k} )$$
where s is the signal that is being corrected, the signal being corrected being one of signals S1, S2, S3, and S4, aₖ is the k-th order harmonic amplitude, and φₖ is the k-th order harmonic phase, and angle is an electrical angle that is calculated based on the signal that is being corrected, the electrical angle being one of the first electrical angle and the second electrical angle, wherein the first electrical angle and the second electrical angle are re-calculated based on the values of signals S1, S2, S3, and S4 after harmonic compensation is performed on signals S1, S2, S3, and S4, and the difference between the first electrical angle and the second electrical angle is determined based on the re-calculated vales of the first electrical angle and the second electrical angle.

4. The system of claim 1, wherein the processing circuitry is further configured to perform harmonic correction on the difference between the first electrical angle and the second electrical angle before the zero-error coefficient is subtracted from the difference between the first electrical angle and the second electrical angle.

5. The system of claim 4, wherein the harmonic correction of the difference between the first electrical angle and the second electrical angle is performed in accordance with the equation of:
$$correctedDifference = D - {\sum }_{i = 1}^{k} {A}_{i} * sin ( i * D + {P}_{i} )$$
where D is the difference between the first electrical angle and the second electrical angle, Aᵢ is an i-th order harmonic amplitude, and Pᵢ is an i-th order harmonic phase.

6. The system of claim 1, wherein:
the first magnetic field is generated by a first target;
the second magnetic field is generated by a second target;
the first target is coupled to a first part of a mechanical system or element;
the second target is coupled to a second part of the mechanical system or element; and
the zero-error coefficient is approximately equal to a value of the difference between the first electrical angle and the second electrical angle when no torque is being applied to the mechanical system or element.

7. The system of claim 6, wherein the first part and the second part are integral with each other.

8. The system of claim 6, wherein the mechanical system or element includes a steering column, the first part includes a lower shaft of the steering column, and the second part includes an upper shaft of steering column.

9. The system of claim 1, wherein:
the first magnetic field is generated by a first set of magnetic features that are part of a first target;
the second magnetic field is generated by a second set of magnetic features that are part of a second target; and
the output signal is indicative of a relative displacement between the first target and the second target.

10. A system, comprising:
a processing circuitry that is configured to:
receive a signal S1 and a signal S2, the signal S1 being generated by a first receiving coil in response to a first magnetic field that is generated by a first set of conductive features in a target, the signal S2 being generated by a second receiving coil in response to the first magnetic field, the signal S2 being approximately 90-degrees off-phase from the signal S1;
receive a signal S3 and a signal S4, the signal S3 being generated by a third receiving coil in response to a second magnetic field that is generated by a second set of conductive features in the target, the signal S4 being generated by a fourth receiving coil in response to the second magnetic field, the signal S4 being approximately 90-degrees off-phase from the signal S3;
calculate a first electrical angle based on signals S1 and S2;
calculate a second electrical angle based on signals S3 and S4;
calculate an angular position of the target based on a difference between the first electrical angle and the second electrical angle and an adjustment coefficient, the adjustment coefficient being based on a count of conductive features in the first set and a count of conductive features in the second set; and
output an output signal that is at least in part generated based on the angular position of the target.

11. The system of claim 10, wherein the adjustment coefficient is calculated in accordance with the equation of
$$δ = ( ( ( θ 1 * {N}_{1} - θ 2 * {N}_{2} + 180 ) \%360 ) - 180 ) ( \frac{2}{{N}_{1} + {N}_{2}} ) ,$$
where δ is the adjustment coefficient, θ1 is the first electrical angle, θ2 is the second electrical angle, N₁ is a count of conductive features in the first set, and N₂ is a count of feet in the second set.

12. The system of claim 10, wherein the angular position of the target is calculated in accordance with the equation of absAngle=(θ1−θ2+δ) % 360, where absAngle is the angular position of the target, δ is the adjustment coefficient, θ1 is the first electrical angle, and θ2 is the second electrical angle.

13. The system of claim 10, wherein the processing circuitry is further configured to perform harmonic compensation on each of the signals S1, S2, S3, and S4, the harmonic compensation being performed in accordance with the equation of:
$$correctedSignal = signal + {\sum }_{k = 1}^{n} {a}_{k} sin ( k * angle + {φ}_{k} )$$
where s is the signal that is being corrected, aₖ is the k-th order harmonic amplitude, angle is one of the first electrical angle and the second electrical angle, and ok is the k-th order harmonic phase, wherein the first electrical angle and the second electrical angle are re-calculated based on the values of signals S1, S2, S3, and S4 after harmonic compensation is performed on signals S1, S2, S3, and S4, and the difference between the first electrical angle and the second electrical angle is determined based on the re-calculated vales of the first electrical angle and the second electrical angle.

14. The system of claim 10, wherein the processing circuitry is configured to perform harmonic compensation on any given one of the of the first electrical angle and the second electrical angle, the harmonic compensation being performed in accordance with the equation of:
$$compensatedAngle = a - {\sum }_{i = 1}^{k} {HA}_{i} * sin ( i * a + {HP}_{i} )$$
where a is the given electrical angle, HAᵢ is an i-th order harmonic amplitude, and HPᵢ is an i-th order harmonic phase, and k is an integer greater than 1.

15. The system of claim 10, wherein the first electrical angle and the second electrical angle are calculated in accordance with the equations of:
$$θ1 = a tan ( \frac{S 1}{S 2} )$$
$$θ2 = a tan ( \frac{S 3}{S 4} )$$
where θ1 is the first electrical angle and θ2 is the second electrical angle.

16. A system, comprising:
a memory; and
a processing circuitry that is configured to:
receive a signal S1 and a signal S2, the signal S1 being generated by a first receiving coil in response to a first magnetic field, the first magnetic field being generated by a first set of conductive features, the signal S2 being generated by a second receiving coil in response to the first magnetic field, the signal S2 being approximately 90-degrees off-phase from the signal S1;
receive a signal S3 and a signal S4, the signal S3 being generated by a third receiving coil in response to a second magnetic field, the second magnetic field being generated by a second set of conductive features, the signal S4 being generated by a fourth receiving coil in response to the second magnetic field, the signal S4 being approximately 90-degrees off-phase from the signal S3;
calculate a first electrical angle based on signals S1 and S2;
calculate a second electrical angle based on signals S3 and S4;
retrieve a configuration setting from a memory;
when the configuration setting has a first value, execute a first process for calculating relative displacement between two different targets that are associated with the first set of conductive features and the second set of conductive features, respectively; and
when the configuration setting has a second value, execute a second process for calculating an angular position of a target associated with both the first set of conductive features and the second set conductive features.

17. The system of claim 15, wherein the first process includes the steps of:
calculating a difference between the first electrical angle and the second electrical angle;
subtracting a zero-error coefficient from the difference between the first angle and the second angle to produce a corrected difference; and
outputting an output signal that is generated at least in part based on the corrected difference.

18. The system of claim 15, wherein the second process includes the steps of:
calculating an angular position of the target that is associated with both the first set of conductive features and the second set of conductive features, the angular position being calculated based on (i) an adjustment coefficient and (ii) a difference between the first electrical angle and the second electrical angle, the adjustment coefficient being based on a count of conductive features in the first set and a count of conductive features in the second set; and
outputting an output signal that is at least in part indicative of the angular position of the target.

19. The system of claim 15, wherein the configuration setting includes a factory-programmed configuration setting that restricts the processing circuitry to executing only one of a plurality of processes that are supported by the processing circuitry.

20. The system of claim 15, wherein, when the configuration setting has a third value, the processing circuitry is further configured to execute a third process for calculating relative displacement between the two different targets that are associated with the first set of conductive features and the second set of conductive features, respectively.

21. The system of claim 20, wherein the third process includes the steps of:
calculating first and second target angles based on the first and second electric angles;
calculating a difference between the first and second target angles; and
outputting an output signal that is generated at least in part based on the difference.

22. A method, comprising:
receiving a signal S1 and a signal S2, the signal S1 being generated by a first receiving coil in response to a first magnetic field, the signal S2 being generated by a second receiving coil in response to the first magnetic field, the signal S2 being approximately 90-degrees off-phase from the signal S1;
receiving a signal S3 and a signal S4, the signal S3 being generated by a third receiving coil in response to a second magnetic field, the signal S4 being generated by a fourth receiving coil in response to the second magnetic field, the signal S4 being approximately 90-degrees off-phase from the signal S3;
calculating a first electrical angle based on signals S1 and S2;
calculating a second electrical angle based on signals S3 and S4;
calculating a difference between the first electrical angle and the second electrical angle;
subtracting a zero-error coefficient from the difference between the first angle and the second angle to produce a corrected difference; and
outputting an output signal that is generated at least in part based on the corrected difference.

23. The method of claim 22, wherein the first electrical angle and the second electrical angle are calculated in accordance with the equations of:
$$θ1 = a tan ( \frac{S 1}{S 2} )$$
$$θ2 = a tan ( \frac{S 3}{S 4} )$$
where θ1 is the first electrical angle and θ2 is the second electrical angle.

24. The method of claim 22, further comprising, performing harmonic compensation on each of the signals S1, S2, S3, and S4, the harmonic compensation being performed before the first electrical angle and the second electrical angle are calculated, the harmonic compensation being performed in accordance with the equation of:
$$correctedSignal = signal + {\sum }_{k = 1}^{n} {a}_{k} sin ( k * angle + {φ}_{k} )$$
where s is the signal that is being corrected, aₖ is the k-th order harmonic amplitude, and φₖ is the k-th order harmonic phase, wherein the first electrical angle and the second electrical angle are re-calculated based on the values of signals S1, S2, S3, and S4 after harmonic compensation is performed on signals S1, S2, S3, and S4, and the difference between the first electrical angle and the second electrical angle is determined based on the re-calculated vales of the first electrical angle and the second electrical angle.

25. The method of claim 22, further comprising performing harmonic correction on the difference between the first electrical angle and the second electrical angle before the zero-error coefficient is subtracted from the difference between the first electrical angle and the second electrical angle.

26. The method of claim 25, wherein the harmonic correction of the difference between the first electrical angle and the second electrical angle is performed in accordance with the equation of:
$$correctedDifference = D - {\sum }_{i = 1}^{k} {A}_{i} * sin ( i * D + {P}_{i} )$$
where D is the difference between the first electrical angle and the second electrical angle, Aᵢ is an i-th order harmonic amplitude, and Pᵢ is an i-th order harmonic phase.

27. The method of claim 22, wherein:
the first magnetic field is generated by a first target;
the second magnetic field is generated by a second target;
the first target is coupled to a first part of a mechanical system or element;
the second target is coupled to a second part of the mechanical system or element; and
the zero-error coefficient is approximately equal to a value of the difference between the first electrical angle and the second electrical angle when no torque is being applied to the mechanical system or element.

28. The method of claim 27, wherein the first part and the second part are integral with each other.

29. The method of claim 27, wherein the mechanical system or element includes a steering column, the first part includes a lower shaft of the steering column, and the second part includes an upper shaft of steering column.

30. The method of claim 22, wherein:
the first magnetic field is generated by a first set of magnetic features that are part of a first target;
the second magnetic field is generated by a second set of magnetic features that are part of a second target; and
the output signal is indicative of a relative displacement between the first target and the second target.

31. A method, comprising:
receiving a signal S1 and a signal S2, the signal S1 being generated by a first receiving coil in response to a first magnetic field that is generated by a first set of conductive features in a target, the signal S2 being generated by a second receiving coil in response to the first magnetic field, the signal S2 being approximately 90-degrees off-phase from the signal S1;
receiving a signal S3 and a signal S4, the signal S3 being generated by a third receiving coil in response to a second magnetic field that is generated by a second set of conductive features in the target, the signal S4 being generated by a fourth receiving coil in response to the second magnetic field, the signal S4 being approximately 90-degrees off-phase from the signal S3;
calculating a first electrical angle based on signals S1 and S2;
calculating a second electrical angle based on signals S3 and S4;
calculating an angular position of the target based on a difference between the first electrical angle and the second electrical angle and an adjustment coefficient, the adjustment coefficient being based on a count of conductive features in the first set and a count of conductive features in the second set; and
outputting an output signal that is at least in part generated based on the angular position of the target.

32. The method of claim 31, wherein the adjustment coefficient is calculated in accordance with the equation of
$$δ = ( ( ( θ 1 * {N}_{1} - θ 2 * {N}_{2} + 180 ) \%360 ) - 180 ) ( \frac{2}{{N}_{1} + {N}_{2}} ) ,$$
where δ is the adjustment coefficient, θ1 is the first electrical angle, θ2 is the second electrical angle, N₁ is a count of conductive features in the first set, and N₂ is a count of feet in the second set.

33. The method of claim 31, wherein the angular position of the target is calculated in accordance with the equation of absAngle=(θ1−θ2+8) % 360, where absAngle is the angular position of the target, δ is the adjustment coefficient, θ1 is the first electrical angle, and θ2 is the second electrical angle.

34. The method of claim 31, further comprising performing harmonic compensation on each of the signals S1, S2, S3, and S4, the harmonic compensation being performed in accordance with the equation of:
$$correctedSignal = signal + {\sum }_{k = 1}^{n} {a}_{k} sin ( k * angle + {φ}_{k} )$$
where s is the signal that is being corrected, the signal being corrected being one of signals S1, S2, S3, and S4, aₖ is the k-th order harmonic amplitude, and φₖ is the k-th order harmonic phase, and angle is an electrical angle that is generated based on signal S, the electrical angle being one of the first electrical angle and the second electrical angle, wherein the first electrical angle and the second electrical angle are re-calculated based on the values of signals S1, S2, S3, and S4 after harmonic compensation is performed on signals S1, S2, S3, and S4, and the difference between the first electrical angle and the second electrical angle is determined based on the re-calculated vales of the first electrical angle and the second electrical angle.

35. The system of claim 31, further comprising performing harmonic compensation on any given one of the first electrical angle and the second electrical angle, the harmonic compensation being performed in accordance with the equation of:
$$compensatedAngle = a - {\sum }_{i = 1}^{k} {HA}_{i} * sin ( i * a + {HP}_{i} )$$
where a is the given electrical angle, HAᵢ is an i-th order harmonic amplitude, and HPᵢ is an i-th order harmonic phase, and k is an integer greater than 1.

36. The method of claim 30, wherein the first electrical angle and the second electrical angle are calculated in accordance with the equations of:
$$θ1 = a tan ( \frac{S 1}{S 2} )$$
$$θ2 = a tan ( \frac{S 3}{S 4} )$$
where θ1 is the first electrical angle and θ2 is the second electrical angle.
